(19) United States
(12) Patent Application Publication
(10) Pub. No.: US 2004/0111388 A1
(43) Pub. Date: Jun. 10, 2004

(54) Evaluating relevance of results in a semi-structured data-base system

(76) Inventors: Frederic Boiscuvier, Saint-Cloud (FR); Sophie Cluet, Suresnes (FR); Bruno Koechlin, Saint Germain en Laye (FR)

Correspondence Address: FRANK R. OCCHIUTI, Fish & Richardson P.C., 225 Franklin Street, Boston, MA, 02110-2804, US

(21) Appl. No.: 10/313,823

(22) Filed: Dec. 6, 2002

(51) Int. Cl. G06F 17/30

(52) U.S. Cl. 707/1

(57) ABSTRACT

A method for evaluating queries applied to semi-structured data, including, providing a query for the semi-structured data, the query includes indication of relevance ranking of sought results. The indication includes specification according to the structural positioning of words in the semi-structured data. The method further provides for evaluating the query vis-a-vis the semi-structured data in accordance with the indicated relevance ranking, and providing results, where each result includes a portion of the semi-structured data that meets the query.

### FIELD OF THE INVENTION

The invention is, generally, in the field of evaluating results in a semi-structured database system.

### BACKGROUND OF THE INVENTION

A very popular database nowadays is the relational database. In a relational database, data is stored in relations (or “tables”). Tables have columns and rows. The rows are often referred to as “records”, and consist of a single related group of data, like complete supplier details. The columns in the tables represent attributes of the rows. A column in a supplier details table might be “supplier name,” just one part of a row.

Relations are defined by a database administrator, and have a fixed format called a “schema.” For instance, the schema for the supplier details relation might be—identification number, name, address, city, state, zip, which is an “identification number” followed by a “name” followed by an “address”, etc. Each supplier details record that appears in the table has to have that exact format. Changes to the schema are quite expensive, and result in significant “downtime” for the database.

Querying relational databases (referred to also as Query Languages in Database Management Systems (DBMS) rely on powerful query languages (e.g., SQL, OQL). These languages provide the ability to manipulate data at a very fine grain using a rich set of operators. The result of a query can vary, from a small piece of information extracted from the database to a new database constructed by selecting and re-structuring (grouping, sorting, removing fields, etc.) parts of the original database. The semantics of database query languages is precisely defined by means of powerful algebra.

Compared to their database counterparts, Query Languages in Information Retrieval Systems (IRS) are rather basic. IRS typically manages unstructured contents such as books, emails, news wires, etc. A query for IRS consists, as a rule, of keywords combined with operators such as and, or, not, phrase. The result of a query is a list of document identifiers (such as list of emails) having the required keywords. The order of this list usually depends on the system, i.e., the query language does not provide arbitrary sorting instructions. To compensate their poor query languages, most IRS implement techniques to improve query results, the most common of which being stemming and relevance ranking, of which the latter will be briefly discussed. Thus, Relevance ranking increases the readability of query answers by ordering the returned documents according to some “relevance” factor. The relevance of a document relatively to a query is a rather subjective notion and, accordingly, each IRS comes with its own definition. Among the different criteria that may enter the computation of relevance, one may find (variations of) the following:

Head preference (referred to also as locality): given two documents d1 and d2 containing a queried word w, d1 will be considered more relevant than d2 if w occurs sooner (i.e., nearer to the start of the document) in d1 than in d2.

Proximity: given two documents d1 and d2 containing two queried words w1 and w2, d1 will be considered more relevant than d2 if w1 and w2 are nearer to each other in d1 than in d2.

Co-occurrence: given two documents d1 and d2 containing a queried word w, d1 will be considered more relevant than d2 if w occurs more often in d1 than in d2.

There are many other such criteria, and obviously a great many ways to combine them according to the query number of words and involved operators. This probably explains why relevance ranking is “hidden” within the systems. Indeed, apart from the difficulty to discover and then define the appropriate relevance formulae, its efficient evaluation heavily depends on maintaining the appropriate data structures.

Having referred, briefly, to Query Languages in Database Management Systems (DBMS) and in Information Retrieval Systems (IRS), there follows a brief overview of Semi-structured data and Query Languages therefor. Note that the description of the semi-structured data and queries therefor is provided for illustrative purposes only and does not aim at capturing all facets of either semi-structured data or the queries therefor. Note also that both are known per se and discussed extensively in the literature. Thus, unlike data that have a fixed schema (as discussed above with reference to relational databases), data that do not conform to a fixed schema are referred to as semi-structured. This type of data is often irregular and only loosely defined. Even in the previous example of supplier details, one can see how semi-structured data could be used. Imagine a database for the supplier details. Some supplier addresses would have cities and states, some would include country and country designator, some would have numeric zip codes, some alphanumeric postal codes, and many would include extra information like “cellular telephone number.” They would be very different, depending on where they originated. In all cases, even though they do not look the same, they are still instances of “supplier details”. A specific instance of semi-structured data is the XML (eXtensible Markup Language) that is used extensively in the Web. Various academic papers and emerging products focus on the generation, storage, and search of XML. The latter is a subset of SGML (Standard Generalized Markup Language).

Semi-structured data “bridges” the chasm between two worlds of Structured data, and Un-structured content described above.

The objective of query languages for semi-structured data (as was defined e.g. by W3C standard, see e.g., http://www.w3.org/XML/Query) is to address the needs of applications dealing with these two different kinds of data. For this, they extend traditional structured database languages with path expressions (as found e.g. in Xpath, see e.g. http://www.w3.org/TR/xpath) and with the main query primitive of information retrieval systems: words containment.

In searching semi-structured data, queries often include information about the structure of the data, not just field contents. For instance, genealogists may care about the grandchildren of a particular historical figure. Such data paths (e.g., the path from “grandparent” to “grandchild”) are often explicit in the semi-structured data, but are not stored explicitly in a relational database, and, a fortiori, not in IRS. The ability to do path searches is an important characteristic of queries for semi-structured databases. A path search is especially useful when the sought type of data is known, but not exactly where in the database. For instance, a query like “find all addresses of all buyers of all invoices” is a search for the path “invoice->buyer->address.” In addition to searching for particular paths, one should be able to search for particular structures within the semi-structured data, like a complete set of “buyer” information, which includes the buyer's name and address. At the same time, semi-structured data may be queried independent of its structure (e.g. key word search, much like IRS).

### SUMMARY OF THE INVENTION

The invention provides for a method for evaluating queries applied to semi-structured data, comprising:

i) providing a query for the semi-structured data, the query includes indication of relevance ranking of sought results; wherein said indication includes specification according to the structural positioning of words in the semi-structured data;

ii) evaluating the query vis-a-vis the semi-structured data in accordance with said indicated relevance ranking; and

iii) providing at least one result, if any, where each result includes a portion of said semi-structured data that meets said query.

The invention further provides for a method for constructing queries for application to semi-structured data, comprising:

i. providing a query for the semi-structured data, the query includes indication of relevance ranking of sought results; wherein said indication includes specification according to the structural positioning of words in the semi-structured data;

ii. transmitting the query for evaluation vis-a-vis the semi-structured data in accordance with said indicated relevance ranking; and

iii. receiving at least one result, if any, where each result includes a portion of said semi-structured data that meets said query.

Still further, the invention provides for a method for constructing queries for application to semi-structured data, comprising:

i. providing a query for the semi-structured data such that said query is formatted to indicated relevance ranking of sought results; wherein said indication includes specification according to the structural positioning of words in the semi-structured data;

ii. transmitting the query for evaluation vis-a-vis the semi-structured data in accordance with said indicated relevance ranking;

iii. receiving at least one result, if any, where each result includes a portion of said semi-structured data that meets said query.

The invention provides for a method for evaluating queries applied to semi-structured data, comprising:

i. providing a query for the semi-structured data, the query includes indication of relevance ranking of sought results; wherein said indication includes specification according to the structural positioning of words in the semi-structured data.

ii. evaluating the query vis-a-vis the semi-structured data in accordance with said indicated relevance ranking; and

iii. providing at least one result, if any, where each result includes a portion of said semi-structured data that meets said query, whereby, results that meet said query in compliance with said relevance ranking, are provided, irrespective of the size of the semi-structured data, provided that the user has not stopped the evaluation process.

Yet further, the invention provides for a computer program product comprising:

computer code for constructing a query for application to semi-structured data, the computer code further facilitates incorporation in the query means for indicating relevance ranking of sought results; wherein said indication includes specification according to the structural positioning of words in the semi-structured data,

whereby said query is capable of being evaluated vis a vis the semi-structured data in accordance with said indicated relevance ranking for receiving at least one result, if any, where each result includes a portion of said semi-structured data that meets said query.

The invention provides for a system for evaluating queries applied to semi-structured data, comprising:

receiver for receiving a query for the semi-structured data, the query includes indication of relevance ranking of sought results; wherein said indication includes specification according to the structural positioning of words in the semi-structured data;

evaluator for evaluating the query vis-a-vis the semi-structured data in accordance with said indicated relevance ranking; said evaluation is capable of providing at least one result, if any, where each result includes a portion of said semi-structured data that meets said query.

The invention further provides for a system for constructing queries for application to semi-structured data, comprising:

generator for generating a query for the semi-structured data, the query includes indication of relevance ranking of sought results; wherein said indication includes specification according to the structural positioning of words in the semi-structured data;

transmitter for transmitting the query for evaluation vis-a-vis the semi-structured data in accordance with said indicated relevance ranking; and

receiver for receiving at least one result, if any, where each result includes a portion of said semi-structured data that meets said query.

Still further, the invention provides for a system for evaluating queries applied to semi-structured data, comprising:

receiver for receiving a query for the semi-structured data, the query includes indication of relevance ranking of sought results; wherein said indication includes specification according to the structural positioning of words in the semi-structured data.

evaluator for evaluating the query vis-a-vis the semi-structured data in accordance with said indicated relevance ranking; said evaluator is capable of providing at least one result, if any, where each result includes a portion of said semi-structured data that meets said query,

whereby, results that meet said query in compliance with said relevance ranking, are provided, irrespective of the size of the semi-structured data, provided that the user has not stopped the evaluation process.

### BRIEF DESCRIPTION OF THE DRAWINGS

For a better understanding, the invention will now be described, by way of example only, with reference to the accompanying drawings, in which:

FIG. 1 illustrates, schematically, a generalized system architecture in accordance with one embodiment of the invention;

FIG. 2 illustrates, schematically, a query processor employing a relevance ranking module in accordance with one embodiment the invention;

FIG. 3 illustrates, schematically, use of a query language for specifying relevance ranking, in accordance with one embodiment of the invention;

FIG. 4 illustrates, schematically, use of a query language for specifying relevance ranking, in accordance with another embodiment of the invention;

FIG. 5 illustrates a description of an XML schema serving for exemplifying the operation of the system and method of the invention in accordance with an embodiment of the invention;

FIGS. 6A-C illustrate, schematically, use of an operator for specifying relevance ranking in respect of three different specific queries, in accordance with one embodiment of the invention;

FIGS. 7A-7C illustrate, schematically, specific tree patterns evaluated in respect of a specific query, in accordance with an embodiment of the invention;

FIG. 8 illustrates a coding scheme, used in query evaluation procedure, in accordance with an embodiment of the invention;

FIG. 9 illustrates, schematically, an index data structure, used in query evaluation procedure, in accordance with an embodiment of the invention;

FIGS. 10A-B illustrate a sequence of join operations, used in a query evaluation process, in accordance with an embodiment of the invention; and

FIG. 11 illustrates, schematically, a sequence of algebraic operations used in a query evaluation process, in accordance with an embodiment of the invention.

### DESCRIPTION OF SPECIFIC EMBODIMENTS

Note that for XML or variants and derivative thereof, semi-structured data may include XML documents. The invention is not bound by specific representation of semi-structured data. For example, in certain embodiments, semi-structured data can be represented as a tree or collection of trees.

Note also that for convenience, the description pertains mainly to XML documents and Xquery query language. The invention likewise applies to any other semi-structured data query language for semi-structured data.

Before turning to describe various non-limiting embodiments of the invention, it should be noted, generally, that in traditional query processing, the whole repository of documents is processed to yield a set of results that meet the query. Each result is a document or portion thereof or combination of portions of documents. The set of results is then evaluated (e.g. ranked according to pre-defined criteria) and displayed to the user. This approach is costly when querying large repositories or applying complicated queries, since the response time to the user may be quite long before the first result is displayed. In contrast, in pipeline processing, the results are processed in steps, such that in each step 1 to n results are processed and the first results are returned fast, typically consuming reduced memory resources.

As will be explained in greater detail below, the invention provides, in certain embodiments, an implementation of the specified indication of relevance ranking in a traditional manner and by other embodiments in a pipelined manner.

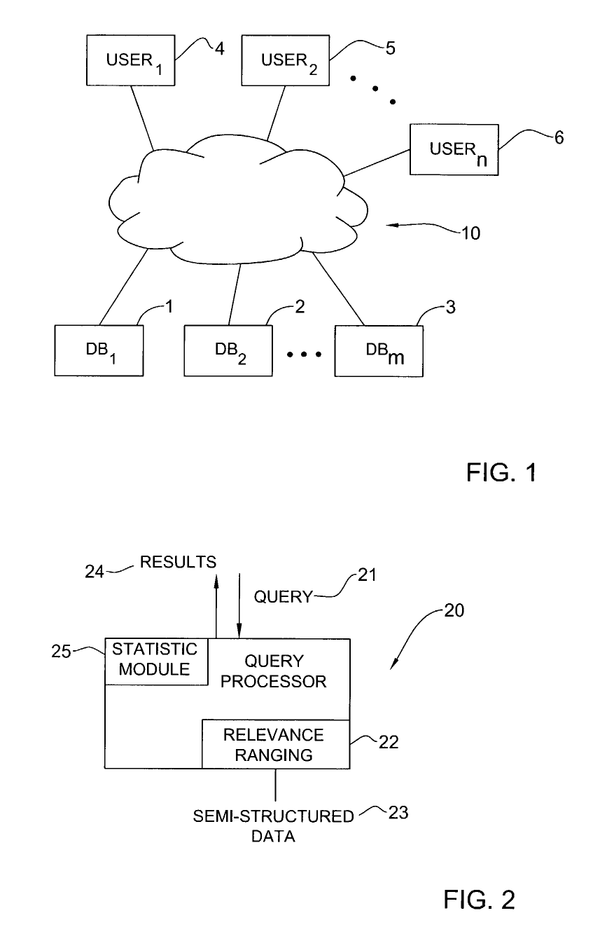

Bearing this in mind, attention is drawn, at first, to FIG. 1, showing a generalized system architecture (10) in accordance with an embodiment of the invention. Thus, a plurality of servers of which only three (designated 1, 2 and 3) are shown, store semi-structured data. Note that each of the servers may have access to other servers and/or other repositories of semi-structured data. Accordingly, the invention is not bound by any specific structure of the server and/or by the access scheme (e.g. index scheme) that it utilizes in order to access semi-structured data stored in the server or elsewhere. System 10 further includes a plurality of user terminals of which only three are shown, designated (4, 5, and 6), communicating with the servers through communication medium, e.g., the Internet.

By one embodiment, there is provided a user application executed, say through a standard browser for defining queries and indicating therein relevance ranking. Thus, for example, a user in node 4 places a query with designation of relevance ranking, the query is processed by query processing module (discussed in greater detail below) using data stored in one or more of the server databases 4 to 6. The resulting data is then communicated for display at the user node. The response time for displaying the data depends, inter alia, on whether a traditional or pipeline approach is used.

The invention is, of course, not bound by any specific user node, e.g., P.C., PDA, etc. and not by any specific interface or application tools, such as browser.

Attention is now drawn to FIG. 2, illustrating schematically, a generalized query processor (20) employing a relevance ranking module in accordance with an embodiment the invention. Query module (20) is adapted to evaluated queries (e.g. (21)) that are fed as input to the module and which meets a predefined syntax, say, the Xquery query language. Continuing with this embodiment, queries can further include relevance ranking primitives which will be evaluated in relevance ranking sub-module (22), against semi-structured data, designated generally as (23), giving rise to results (24). Note that whereas query processor 20 was depicted as a distinct module, it may be realized in many different implementations. For example, the whole query processing evaluation may be realized in one DB server or executed in two or more servers in a distributed fashion. By way of another non-limiting example, part of the query evaluation process may take place in a user node.

In accordance with one embodiment of the invention, there is provided a new use of existing semi-structured query language (e.g. Xquery query language) that is formulated in a manner for performing relevance ranking. This is based on the underlying assumption that the documents structure (to which the query applies) is known and that certain parts thereof can be queried according to the desired relevance. This is a non-limiting example of usage of the structural positioning of the words in order to specify the desired relevance ranking. Note that words refer to leaves.

Accordingly, by this embodiment, the more important parts (having higher rank insofar as the user interest is concerned) are queried first and the less relevant parts (having lower rank) are queried afterwards etc. Thus, when knowing the documents structure, it is, for instance, possible to achieve head preference by requiring first the documents that contain the given words in the first part of the document structure (having, in this context, higher relevance ranking) then in the second part (having, in this context, lower relevance ranking), and so on.

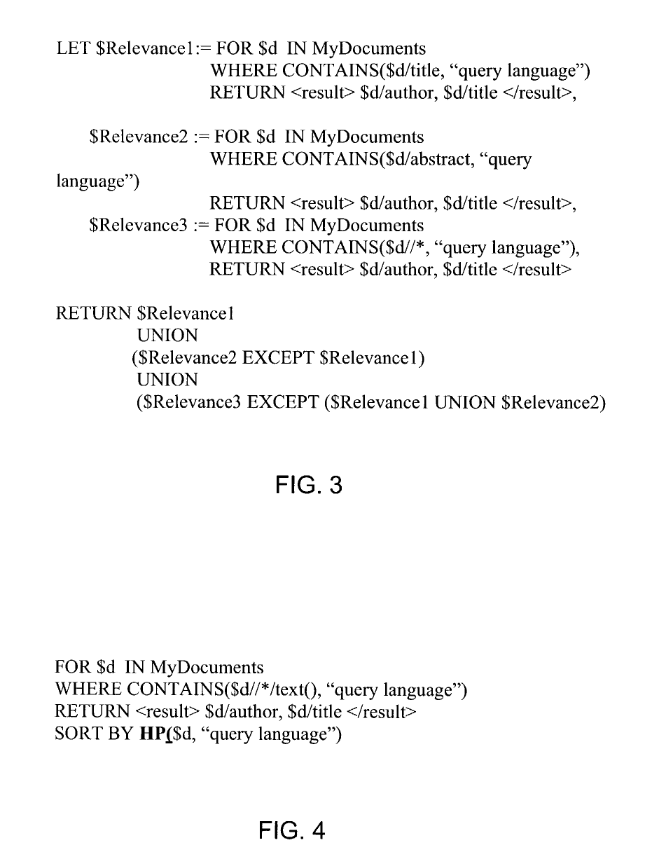

For a better understanding of the foregoing, consider an exemplary set of documents with title, abstract and body. The X-Query example (being a non-limiting example of semi-structured query languages) illustrated in FIG. 3 returns, ordered by “head preference”, the titles and authors of the documents containing “query language”. This embodiment of the invention is not bound by the specific use of Xquery, and accordingly, other query languages for semi-structured data can be used, depending upon the particular application.

As shown, in the first phase a first clause, designated Relevance1, is evaluated which calls for retrieval of documents having at their title the combination “query language” (hereinafter first list). Then, in the second phase, the second clause, designated Relevance2, is evaluated which calls for the retrieval of documents having at their abstract the combination “query language” (hereinafter second list). However, since some of the documents in the second list were already retrieved in the first list (i.e. they have “query language” both in the title and in the abstract), it is required to exclude those that were already retrieved in the first phase and this is implemented using the EXCEPT primitive (i.e. $Relevance2 except $Relevance1). Now the two sets need to be unioned. Consider, for example, a first document d1 where “query language” appears in the title and the abstract, a second document d2 where “query language” appears only in the title and a third document d3 where “query language” appears only in the abstract. Then, Relevanve1 would give rise to d1 and d2; Relevanve2 would give rise to d1 and d3; and after applying EXCEPT d3 remains and eventually the UNION give rise to d1, d2 and d3.

Note that already at this stage it is clear that the results can be provided at least partially in a pipelined fashion since at first the results at the higher rank (where the combination “query language” appeared in the title, e.g. d1 and d2 in the latter example) are retrieved and thereafter in the second phase the documents having lower rank (where the combination “query language” appeared in the abstract, e.g. d3 in the latter example) are retrieved. Reverting now to the above example, and turning to the lowest rank, the third clause (implemented by the statement $Relevance3 EXCEPT ($Relevance1 UNION $Relevance2) will give rise to documents having at their body the combination “query language”.

Note that the evaluation is performed in phases according to the rank, each phase eventually decomposed into steps, whereby in this embodiment, the higher rank (title) is initially evaluated. For each rank (say the highest one-title) the evaluation is performed in one or more steps where in each step one or more results are obtained. The step size, may be determined, depending upon the particular application. Note also that whereas by this example, full documents were retrieved as a result, by another non-limiting embodiment, only relevant portions thereof are retrieved, all depending upon the particular application.

The pipeline evaluation afforded by the use of semi-structured query language in accordance with this embodiment of the invention is an important feature when large collections are concerned. Indeed, keyword searches (such as in IRS, see discussion above) are not always selective and may lead to returning a large portion of the database (even the full database). By returning/evaluating first results fast, a system (i) heavily reduces memory consumption, (ii) gives more satisfaction to its users who do not have to wait to get a first subset of answers, and (iii) potentially reduces processing time since users can stop the evaluation after the n first subsets of answers. Another advantage in accordance with this embodiment is that there is no need to modify the existing semi-structured query language, but rather it is used in a different fashion to facilitate relevance ranking in semi-structured databases.

In accordance with another embodiment of the invention, ranking queries by relevance relies on at least one external function, e.g. function(s) defined in a programming language that does not form part of the semi-structured query language itself but which can, nevertheless, be applied within the language. The query language is, thus, formatted to indicate the relevance ranking, using this external function.

For instance, assume that the function named HP( ) has been developed to compute “head preference”. An exemplary use of same query (as in FIG. 3) in accordance with this embodiment is illustrated in FIG. 4. Thus, the identification and titles of the documents having the combination “query language” will be retrieved, after having been sorted in accordance with the results of the HP function which orders first the documents having this combination at their title, then documents having this combination at their abstract, and lastly documents having this combination at their body. Note that in the latter embodiment, the evaluation requires the accumulation of all results before the first one can be returned to the user, thereby offering traditional and not pipeline evaluation.

In accordance with another embodiment of the invention, there is provided a technique for incorporating, in a semi-structured query language, means for indicating relevance ranking. By one embodiment, this is accomplished by the provision of a distinct operator which can be integrated in the semi-structured query language. This affords a simple manner of designation of relevance ranking in semi-structured query languages as well as in a scalable way in order to efficiently evaluate a query on a large database so as to return the most relevant results fast.

Thus, by one embodiment, there is provided an operator designated BESTOF, allowing users to specify relevance in a simple way. Note, generally, that there are many ways to evaluate relevance depending upon, inter alia, the application and/or the user. Note, that even when the same application is concerned two queries within the same application may require different ways to compute relevance.

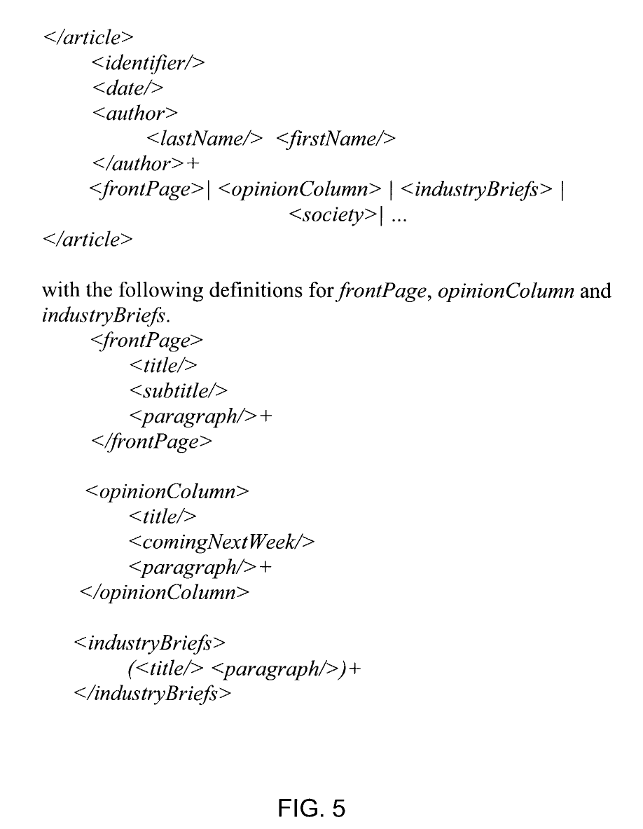

For a better understanding of the foregoing, consider, for instance, an application that manages the archives of a newspaper whose document tree structure is as depicted in FIG. 5. FIG. 5 defines an article with article identifier, date and author(s) details as well as distinct definitions for front page (title, subtitle, and one or more paragraphs), Opinion Column(title, ComingNextWeek and one or more paragraphs), and IndustryBriefs (one or more titles and paragraphs).

Bearing in mind this structure Consider the two following queries:

get the articles talking about “war” and “Afghanistan”

get the articles talking about the “merger” of Companies “X” and “Y”

Obviously, word proximity is important in both queries. Another important criterion for both queries is the head preference, i.e. position of the words within the documents, say, preferably, in the title. Thus, for the first query, finding “war” and “Afghanistan” in the title field of the document is certainly better than finding them in some arbitrary paragraph or, worst, in the comingNextWeek field of opinionColumn. By the same token, for the second query finding “merger” and “X” and “Y” in the title would be better than finding them in some arbitrary paragraph or, worst, in the comingNextWeek field of opinionColumn.

However, for a lower preference there may be different definitions. For example, for the second query a best candidate (for second preference) may be to find “merger” and “X” and “Y” in paragraph below industryBriefs, rather than simply paragraph. This condition is, obviously, of no relevance for the first query since finding “war” and “Afghanistan” in Industry Briefs is of very little or possibly no relevance.

By this embodiment, the BESTOF operator would be able to capture the specified distinctions and others, depending upon the specific application and need. In this context the specified example with reference to the two queries and the document depicted in FIG. 5 is provided for clarity of explanation only and are by no means binding as to the granularity that the BESTOF operator can be used in order to capture the user's preference.

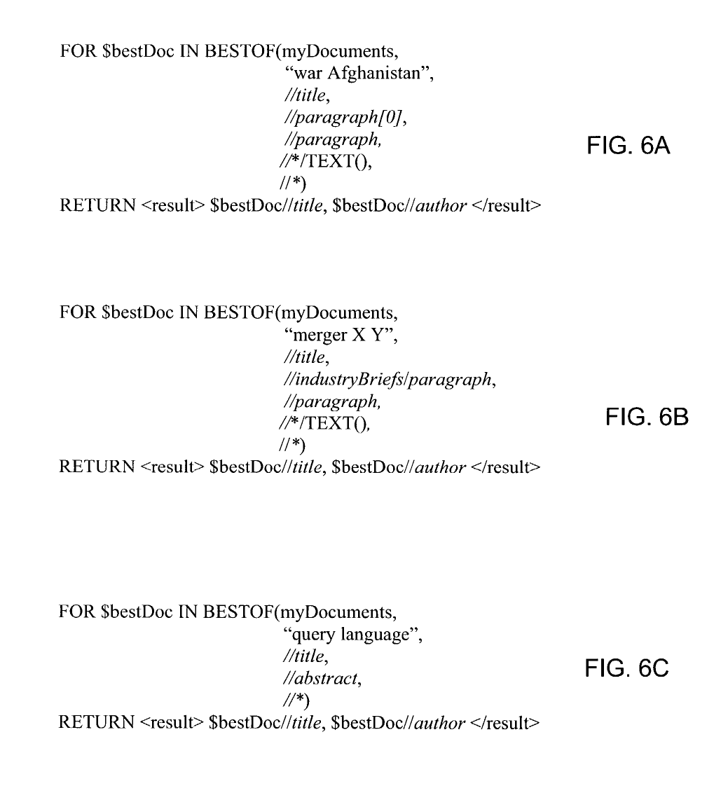

Continuing with this non-limiting example, an appropriate indication of relevant ranking for the two queries using the BESTOF operator would be formulated in an exemplary manner as illustrated in FIG. 6A (for the first query) and 6B (for the second query).

Thus, as shown in FIG. 6A, for the first query the first priority would be title, the second would be in the first paragraph (designated paragraph[0] in FIG. 6A) and the third priority is in any other paragraph of the document. For the query in FIG. 6B, the first priority would be title, the second would be in a paragraph in IndustryBriefs and the third priority is in any paragraph of the document. Using the BESTOF operator for the query described with reference to FIG. 3, would lead to the form depicted in FIG. 6C, where the first priority is to locate “query language” in the title, then in the abstract and finally elsewhere. Note that the structural positioning of the words in the document (by this example the scheme of FIG. 5) is utilized for the relevance ranking.

In accordance with this specific embodiment, the syntax of a BESTOF operation (used in the exemplary queries of FIGS. 6A, 6B and 6C) is the following:

BESTOF (F, SP, P1, P2, P3, . . . )

Where:

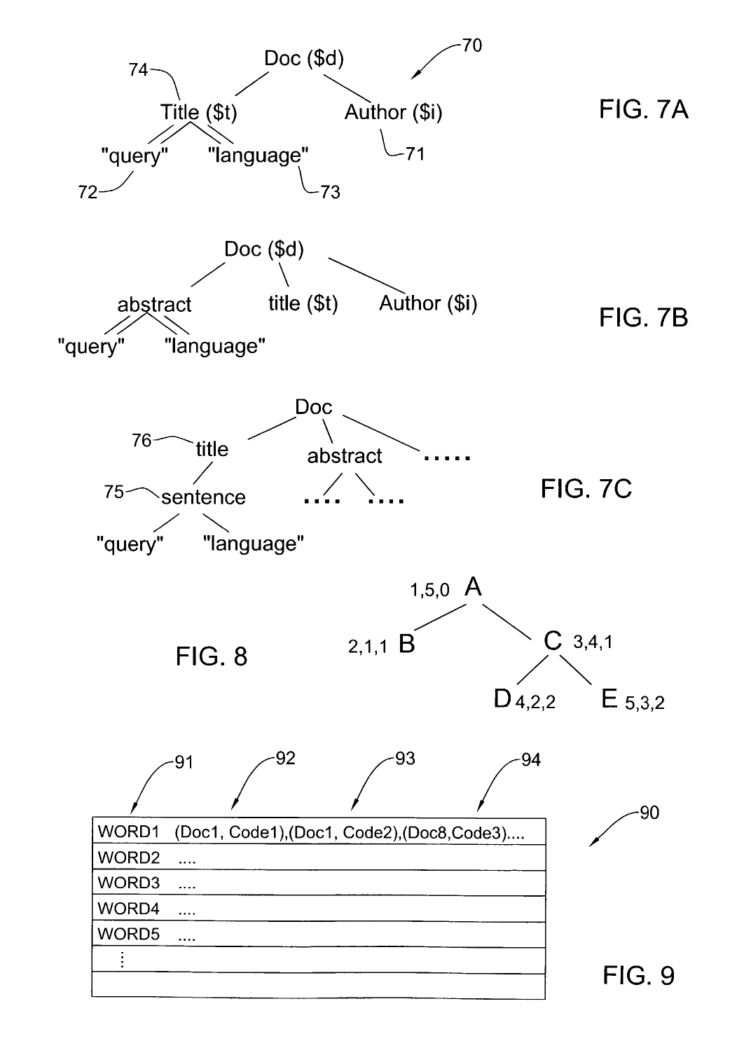

1. F: a forest of XML nodes (i.e., documents; note that a node designates the subtree rooted at this node, for instance, in FIG. 7a, “DOC” is a node and it represents the tree rooted at this node), elements, text,.—for instance, myDocuments specified in the non-limiting examples of FIGS. 6A-C)

2. SP: a string predicate. In the examples illustrated with reference to FIGS. 6A to 6C, the predicate was a simple string (e.g. “war” “Afghanistan”) and considered as a conjunction of words. It is, of course, possible to build more complex predicates using standard connectors, such as: and, or, not, phrase. For instance, (& (| “war” “conflict”) “Afghanistan”) matches any string/element containing “Afghanistan” as well as either “war” or “conflict”. One can also mix path expressions and words. For instance, assume that a sub-element named keywords is added to each element in the document. Then, a predicate could be (& (| “war” “conflict”) “keywords//Afghanistan”). It would match any element with a sub-element keywords containing “Afghanistan” and also containing either “war” or “conflict”. The expressive power of SP can be extended to any arbitrary function.

3. P1, P2, . . . , Pn: 1 to many XPath expressions; for instance P1 stands for //title, and P2 stands for //paragraph[0] in the example of FIG. 6A.

The result of the BESTOF operation is a re-ordered sub-part of the forest F defined as follows: BESTOF(F, SP, P1, P2, . . . , Pn)=Fres={N1, N2, N3, Nm} with:

I. For all nodes N in F, if there exists j in [1,n] such that Pj applied to N satisfies SP then N is part of Fres. In simple words, this condition requires that for each resulting document in the result set, there exists at least one Xpath expression among P1, P2, . . . , Pn that satisfies the string predicate SP.

II. For all i in [1, m] there exists j in [1,n] such that Pj applied to Ni satisfies SP. Let jmin(i) be the smallest such j for a given i. In simple words, this condition requires that the result set consists of only such documents. jmin(i) is an auxiliary operator which will serve for ordering the documents by their rank, as will be explained in greater detail with reference to the following condition (C):

III. For all i in [1, m−1], (jmin(i)<jmin(i+1)) or (jmin(i)=jmin(i+1) and Ni is before Ni+1 in F). This condition deals with the order of the documents, i.e. specify that a first document will be ordered (in the result) before a second document. This condition is satisfied when either of the following conditions (1) or (2) are met:

1) jmin(i)<jmin(i+1), i.e. the higher ordered document has higher rank (where jmin is an auxiliary operator used to this end). For example, when referring to the example of FIG. 6A, a first document having “war” and “Afghanistan” in the title has a smaller jmin(i) value then a document having “war” and “Afghanistan” in the abstract (with higher jmin(i+1) value), and therefore the former will be ordered before the latter. This illustrates in a non limiting manner structural positioning of words. Thus the word in the “title” has a “better” position in the structure compared to word in other (inferior) position in the structure, i.e. the “abstract”. Note that the specification of positioning is by way of path expression, e.g. document//title compared to document//abstract.

2) (jmin(i)=jmin(i+1) and Ni is before Ni+1 in F); this means that the two documents have the same rank (e.g. both having “war” and “Afghanistan” in the title), as indicated by jmin(i)=jmin(i+1) BUT the first document is located before the other in the searched repository, and therefore will also be ordered before in the result.

Note that the invention is not bound by the specific example of BESTOF operator, as well as by the specific syntax and semantics thereof, which is provided herein by way of example only.

Note also that by this example, BESTOF captures the head preference criterion in the relevance computation. Thus, for example, documents having the sought string in the title were ranked before those having the sought string in the abstract. The BESTOF operator can capture other criterion such as proximity (being another example of utilizing structural positioning of words and re-occurrence, as will be explained in greater detail below).

By another embodiment, the BESTOF operation returns the nodes found at the end of the Pi paths rather than the nodes in F. Put simply, instead of returning the documents, the paragraphs in the documents, portions thereof, e.g. a portion of a document satisfying the string predicates is returned.

Having described a non-limiting example an indication of relevance ranking which specifically concerns a provision of an operator which can be integrated in a semi-structured query language, there follows a discussion which pertains to how the actual evaluation of semi-structured data is performed using such an operator. Note that the invention is not bound by the specified operator (as well as by the syntax and/or semantics thereof) and, likewise, not by the specific implementation details of the non-limiting embodiments discussed below.

Before moving to discuss the evaluation details for the semi-structured query language, it is noted, generally, that in information retrieval systems (IRS as discussed above in the background of the invention section) queries are traditionally evaluated as follows:

1. A full-text index is scanned to retrieve, for each query word, a list of information concerning the documents that contain this word. The information usually consists of the document identifier and the offset of the word in the document.

2. The lists are combined in much the same way that words are combined in the query: “And”-ed words lead to intersection, “Or”-ed words to union, etc. To speed up this part of the evaluation, IR systems usually rely on an ordering of the information by document identifier.

3. The relevance of each result of stage 2 above by system-specific functions is computed and the results are sorted accordingly.

The main drawback of this approach is that, for each query, the result of stage 2 has to be stored so that it can be re-ordered according to relevance in stage 3.

When the query is not very selective and the database is large, this can be prohibitive, especially if the system has to deal with several queries at the same time. This is why most systems implement a limit. When in stage 2, the number of results reaches this limit, stage 2 simply stops, not considering the other potential answers. Since, at this point, the results are not ordered by relevance, this means that it is possible to miss the most relevant answers. Another drawback of the approach is that the full result has to be computed before the users can see the query first results.

In accordance with the embodiment that utilized the BESTOF operator, the results are also computed in phases. Note that each phase being eventually decomposed into one or more steps. In contrast to the traditional evaluation strategy discussed above, the phases are based on relevance. More precisely, phase 1 computes the most relevant answers, step i the answers that are more relevant than that of phase i+1 but less than that of phase i−1. This is made possible by the ordering of the path expressions in the BESTOF operation (condition C, discussed above in connection with the results of BESTOF). Note that by this embodiment the algorithm is simple enough, i.e., phase i computes the results corresponding to the ith path expression.

An advantage of the evaluation strategy in accordance wit this embodiment is that the first results can be returned as soon as they are computed. This is obviously good for the user but also for the system. Indeed, if after having read the n first results the user is satisfied by the answer, the system will not have to compute the remaining answers.

For simplifying the description, the evaluation strategy of the relevance ranking can be defined as follows: Consider BESTOF as a sequence of operations, one per path expression. For instance, the query depicted in FIG. 6C is viewed as a sequence of 3 (pseudo) X-queries:

### EXAMPLE 1

FOR $bestDoc IN myDocuments

WHERE CONTAINS($bestDoc//title, “query language”)

RETURN<result>$bestDoc//title, $bestDoc//author</result>

FOR $bestDoc IN myDocuments

WHERE CONTAINS($bestDoc//abstract, “query language”)

RETURN<result>$bestDoc//title, $bestDoc//author</result>

EXCEPT PREVIOUS RESULTS

FOR $bestDoc IN myDocuments

WHERE CONTAINS($bestDoc//*, “query language”)

RETURN<result>$bestDoc//title, $bestDoc//author</result>

EXCEPT PREVIOUS RESULTS

Assuming that by a specific operational scenario the User asks n results at a time. Each time, the evaluation starts where it has stopped the previous time, consuming the queries in sequence when needed. Each time, the results are stored in the memory and the evaluation ensures that they won't be evaluated and sent (i.e. delivered to the user) again. This is needed because there might be an overlap between two sub-queries, and the system avoids the irritation (insofar as the user is concerned) of delivering the same document again and again in the result list. For example, a document which has the terms “query” and “language” in the title will be delivered as a result when the //title Xpath is evaluated but if it also includes this combination in the abstract, the document will not be delivered again in the result when the //abstract Xpath is evaluated.

By this embodiment, the evaluation stops as soon as the user is satisfied. Note that when there are many results, the user is usually satisfied by the first ones and this strategy leads in certain operational scenarios to a great gain. However, where there are few or no results, this strategy leads to evaluating several queries instead of just one. This imposes only limited computational overhead due to the efficient implementation of the evaluation strategy in certain embodiments that utilize in-memory structure, as will be discussed in greater detail below.

Moreover, in accordance with one embodiment, a known per se statistic module (25 in FIG. 2, e.g. used by a known per se database systems, such as Oracle, DB2, etc.) is employed in order to select pipeline evaluation strategy (for many expected results) or traditional evaluation strategy (for few or no expected results). What would be regarded as many results or few results, may be configured, depending upon the particular application.

Note that this evaluation by phases, set forth above, seems similar to the embodiment discussed with reference to FIG. 3, however, as will be better apparent from the detailed discussion below, there is a difference: unlike example of FIG. 3, the system, in accordance with this embodiment, generates the EXCEPT statements, on the fly, and knows what and why they are needed. This knowledge allows optimizing these EXCEPT statements in an appropriate way.

Bearing all this in mind, there follows a detailed discussion of the realization details of the BESTOF operator in accordance with one embodiment of the invention. By this embodiment, the BESTOF operation is realized using a combination of three physical algebraic operators, designated FTISCAN, RELAX and LAUNCHRELAX. The advantage of this approach is that the BESTOF operator can be seamlessly integrated in most database systems since, in many cases, they rely on algebras for the optimization and processing of queries. Note that the invention is by no means bound by this specific realization of the BESTOF operator or the manner in which it is integrated to existing semi-structured query language.

There follows a more detailed discussion of FTISCAN, RELAX and LAUNCHRELAX. Thus,

1. FTISCAN retrieves from an index, in a pipeline mode, the identifiers of the XML nodes satisfying a tree pattern. The tree pattern captures any combination of XPath expressions and string predicates one can apply to a forest of documents. The step evaluation by this embodiment is well fined tuned since a document is retrieved and delivered to the result list upon evaluation thereof, rather than completing the evaluation of the query (say, all the documents that the sought words appear in the title) and only then delivering the documents as a result.

For instance, FIG. 7A below illustrates the pattern tree corresponding to the first phase of Example 1, above.

Considering the first phase of the evaluation of Example 1 (with reference also to FIG. 7A), a correct combination is a tuple with four entries corresponding to title, author, “query” and “language” and such that each entry has the same document identifier (71) and shares the appropriate ascendance relationship. I.e., “query” (72) and “language” (73) are descendant of title (74).

Note here another non-limiting example where the structural positioning of the words in the document are utilized for specifying relevance ranking (by this example the higher rank of interest as defined by the specified tuples).

Note also that by this embodiment, the entries are ordered in the index so as to allow pipelining and avoid considering twice the same entry when computing the combinations. In other words, at worst, the evaluation of a pattern over a forest of documents (in the present case, the evaluation of one sub-query in the sequence corresponding to a BESTOF operation) requires a scan over all the entries corresponding to the query words and word element. E.g., title, author, “query” and “language” in the first phase of the Example illustrated in FIG. 6C. This is in fact a worst complexity that is rarely reached since:

The index implements “accelerators” (or secondary indexes) for words/elements with many entries in the index. Once an entry is chosen for one word/element of the query (e.g., “language”), an accelerator can be used on each frequent word/element (e.g., title) to skip part of the scanning and go as near as possible to its next valid entry.

The entries are grouped by documents. Thus, once an entry has been chosen for one word/word element, scanning the other words/word elements entries that do not correspond to the same document is avoided.

FTISCAN also memorizes the minimal information to avoid evaluating and retrieving twice the same result in the context of a BESTOF operation. In Example 1, this minimal information is the document identifier. This information is also used to avoid unnecessary scanning. Thus, a document whose identifier is already stored will not be reviewed again in subsequent phases, for instance, in the second phase of EXAMPLE 1 above, where the combination “query” and “language” is searched in the abstracts of the documents. This characteristic brings about an inherent realization of the EXCEPT operator, since documents whose identifiers are stored (meaning that they were delivered to the user as a result) will automatically be excluded from future consideration.

Reverting to the specific realization of the FTISCAN, its implementation by this embodiment, relies on the existence of an index that associates to each word or element a list of entries of the form: (document identifiers, position within the document). The position is computed in such a way that given two nodes within the same document, their ascendance relationship is known (i.e., one is an ancestor/parent of the other or they are not related). This information is used to join the entries corresponding to all the words/elements of the query so as to get the combinations satisfying the tree pattern.

For a better understanding of the foregoing, attention is drawn to FIG. 8 that illustrates a coding scheme, used in query evaluation procedure, in accordance with an embodiment of the invention.

In order to answer structured queries such as “name” is a parent of “Jean”, or “person” is an ancestor of both “name” and “address”, a so called Dietz's numbering scheme is used, (exemplified with reference to FIG. 8) in accordance with one embodiment. More precisely, each word that is encountered in the document is associated with its position in the document relatively to its ancestor and descendant nodes. Note that this is performed as a preparatory stage that precedes the actual query evaluation.

The position is encoded by three numbers that are designated pre-order, post-order and level. Given an XML tree T, the pre and post order numbers of nodes in T are assigned according to a left-deep traversal of T. The level number represents the level tree.

This encoding is illustrated in FIG. 8. Thus, the left number for each node is the pre-order number, i.e. signifying visit order of the nodes in left traversal of the tree, i.e. A, B, C, D, E, and accordingly, these nodes are assigned with pre-order numbers 1, 2, 3, 4, 5, respectively. The middle number represents post-order numbers, signifying the post order visit of the nodes, i.e. B,D,E,C,A and accordingly, these nodes are assigned with post-order numbers 1, 2, 3, 4, 5, respectively. The right number in the code is the level number in the tree, i.e. 0 for A, 1 for B and C, and 2 for D and E.

Bearing this in mind, the following conditions hold true:

n is an ancestor of m if and only if pre(n)<pre(m) and post (m)>post(n)

n is an parent of m if and only if n is an ancestor of m and level(n)=level(m)−1 By the index scheme of this embodiment, the preliminary encoding described with reference to FIG. 8, would assign for every word appearing in a document its code, and this applied to all the documents that are to be queried.

For a better understanding, consider, for example, the full index 90 (FIG. 9) for the words in the repository of documents to be queried, residing in one or more servers (see FIG. 1). Word1, word2 and onwards are all the words appearing in one or more documents. Note that the term ‘word’ encompasses a leaf word (e.g., “query”) or the name of an element (e.g., Title). For each word, say word1, the index data structure includes pairs, each, designating a document and a code. Thus, word1 (91) is associated with three pairs, the first (92) indicates that Word1 is found in document no 1 (Doc1; note that Doc1 is in fact identifier specifying the location of this document in the repository machine), and that its code is code1 (i.e., the triple number code explained above, with reference to FIG. 8). Similarly, the second pair (93) indicates that the same word appears in the same document Doc 1, however, in a different location—as indicated by code2, and the third pair (94) indicates that the same word appears in document no. 8 and at location identified by code3, and so forth. Note that the invention is not bound by the specific full index scheme, discussed above.

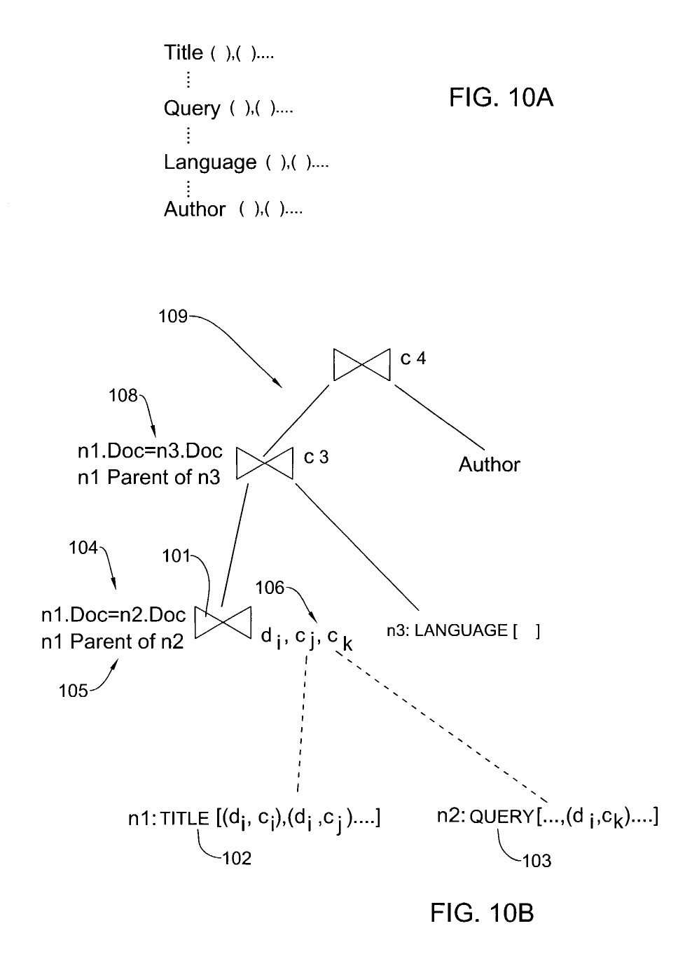

Attention is now drawn to FIGS. 10A-B illustrating a sequence of join operations, used in a query evaluation process, in accordance with an embodiment of the invention. One will recall that there is already available an index (see, e.g. FIG. 9) for all the words of semi-structured documents.

In particular, the index includes all the words of the pattern tree of the present example, i.e. 70 of FIG. 7A. FIG. 10A illustrates the relevant entries in the index table that concern only the words of the query pattern tree 70, each associated with pairs of document number (Di) and code (Ci). In FIG. 10A, the associated pairs are shown, for clarity, only in respect of the pattern of FIG. 7A. If there are more pattern query trees (say the one depicted in FIG. 7B, discussed below), the evaluation process applies, likewise, to each one of them. For simplicity, the description below assumes that only one pattern tree 70 of FIG. 7a that is now subject to evaluation.

The goal of the query evaluation stage is to find document or documents that include all the words and maintain the hierarchy prescribed by the query tree.

One possible realization is by using a series of join operations, shown in FIG. 10B. The invention is by no means bound by this solution. Taking, for example, the first condition, it is required that the words query) and title appear and that the latter is a parent of the former. To this end, a join operation 101 is applied to the pairs (di, cm) of Title 102 (designated also as n1) and the pairs (dj, cn) of Query 103 (designated also as n2). Respective pairs of Title and Query will match in the join operation only if they belong to the same document (i.e. n1.doc=n2.doc 104-) and n1 is a parent of n2 (105). The former condition is easy to check, i.e. the respective pairs should have the same di member of the pair. The second, i.e. parenthood, condition can be tested using the “parent” condition between the code members in the pair, as explained in detail, with reference to FIG. 8. The matching codes (for the same documents) result from the join operation. Thus, the document is di and the respective codes are cj (for Title) and ck for Query (106). Note that the location of the words Title and Query in di can readily be derived from the respective codes cj and ck. There may be, of course, more than one document and/or more than one pair per document which result from the join operation.

Next, another join is applied to the results of the previous join (i.e. document di with Doc Title and Query that maintain the appropriate parent child relationship) and Language (designated n3). Note from FIG. 7A (70) that title is a parent of Language. The join conditions are prescribed in 108, i.e. still the same document is sought: n1.doc=n3.doc, and further that n1 is a parent of n3. In the case of successful result, in addition to the specified cj and ck codes (for Title and Query) additional code c3 is added, identifying the location of language in the same document (di), obviously whilst maintaining the constraints, i.e. that title is a parent of Language. In the same manner, another join is performed for the author designated collectively as 109. In the case of success, author has a resulting code or codes identifying its location in the document (by this example c4). The net effect is, therefore, that location of the sought words (appearing in the pattern tree) in the document (or documents) is determined (by their respective codes) and the structural relationship is maintained between them, in the manner prescribed by the query tree.

Note that if the index is arranged in an appropriate manner (e.g. sorted by document identifiers and then by prefix, i.e. the di, ci discussed above) then the join can be evaluated efficiently and in pipeline mode, using a merge algorithm.

Having described the FTISCAN operator and in manner of operation, there follows a discussion that pertains to the RELAX operator. Thus,

2. RELAX is used on top of an FTISCAN operation and implements the change of phases corresponding to a BESTOF operation (i.e. moving from higher rank to a lower one). It modifies the tree pattern of the FTISCAN going from on BESTOF path expression to the next. E.g., when going from phase 1 to 2 in Example 1, the tree of FIG. 7A is changed to the tree of FIG. 7B, expressing also the constraints in respect of abstract, i.e. abstract is a parent of “query” and “language” (meaning that “query” and “language” need to be found in the abstract). Note that title remains because it is required by the RETURN clause, i.e. the user is interested in receiving as a result the document author and the title thereof.

3. LAUNCH RELAX controls the activation of the RELAX operator, i.e., the timing of the phase changes. Note that the designation of the ranking by means of the pattern tree, utilize the structural positioning of the words in the tree.

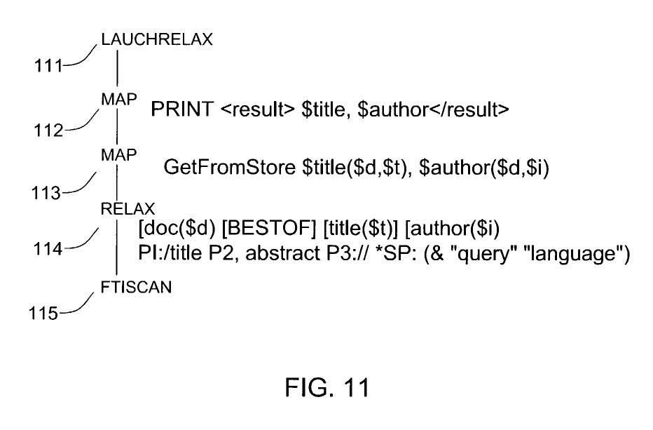

Having described the distinct operators, their operation will now be exemplified with reference to FIG. 11 that illustrates a full algebraic plan that corresponds to Example 1, above. The invention is not bound by this particular implementation.

By this non-limiting example, each operator implements a three standard iterative functions: open (to initialize the operation and its descendant(s)), next (to get the next result) and close (to free its allocated data structure and, through recursive calls, that of its descendants). A fourth one is added, stop, that corresponds to a light close (memory is not freed). The next function returns true if it finds a new result, false otherwise.

The full initialization of the plan is obtained by calling open on its root (i.e., LAUNCHRELAX 111). Then, next is performed as many times as required by the user. For instance, if the user asks to see results n by n, n nexts will be performed. If she is not satisfied by the first n results, another n results will be calculated and so on. The evaluation stops and a close is performed on the root if either the user is satisfied with the collected answers or there are no more results available (i.e., the next on the root operator returned false). A more detailed discussion follows:

Briefly speaking, on opening, LAUCHRELAX (111) records the fact that it is in its first phase of evaluation and pass this information to RELAX. On opening, RELAX (114) uses this information to construct the corresponding tree pattern. This pattern is passed down to the FTISCAN (115). The first next on LAUCHRELAX launches recursive next calls that lead to the construction of the first result bottom up: FTISCAN returns identifiers for Variables $doc, $t and $a that satisfies the tree pattern and memorizes the DOCUMENT identifier of the documents that have been returned, RELAX does nothing, the lowest MAP (113) operation extracts the values corresponding to $t and $a from the store, and the next MAP (112) constructs the result. The end of the first phase occurs when FTISCAN returns false. Upon receiving false, LAUNCHRELAX stops its descendants and re-opens them after having incremented its phase counter. This results in RELAX constructing the next pattern (i.e. changing from the pattern tree of FIGS. 7A to 7B). The end of the process occurs either when there is an outside call to close or when, upon opening, RELAX returns false because there are no more paths available.

The inter-relationship between the FTISCAN, RELAX and LAUCHRELAX and the open, next, close and stop commands will be better understood from the following simplified operational scenario.

Assume that there are only two documents in myDocuments that contains “query language”. These documents are: Document d2 with title t1 and author a1, and Document d2 with title t2 and author a2.

In d1, “query language” occurs in the title, in d2 it occurs in the abstract (and not in the title).

Assuming now that the user asks for 5 results. This means that, on the root of the algebraic tree (i.e., LauchRelax 111), Open is called, then 5 Next (unless the evaluation terminates before), and finally a Close.

1) Open: upon receiving the Open message, LauchRelax (111) records the fact that it is the first evaluation phase. Then, it calls Open on its child (Map 112) that calls Open on its child (2d Map 113) that calls Open on Relax (114). Upon receiving the Open message, Relax constructs the pattern tree corresponding to the current phase (recorded by LauchRelax 111) and calls Open on FTIScan (115) that does nothing.

2) Next(s)

2.1. First Next:

LauchRelax (111) calls Next on its child (Map 112) that calls it on its Child (2d Map 113) that calls it on Relax (114) that calls it on FTIScan (115). This sequence of referred to herein as top-down calls. FTIScan finds that [d1, t1, a1] satisfies the pattern tree and returns true along with the result. Going up, Relax (114) returns true, the 2d Map (113) extracts the values corresponding to t1 and a1 from the store and returns true, the 1st Map (112) prints the values and returns true, LauchRelax returns true.

2.2. Second Next

Again, top-down calls are executed, but this time, FTIScan (115) cannot find a new result for the given patternTree. Thus it returns false, so does Relax (114), and the two Maps (113 and 112). Upon receiving the false value, LauchRelax (111) stops all its descendant operations. Then, it records the fact that it enters the evaluation second phase and re-opens the operators as in 1). However, this time, Relax (114) builds the PatternTree corresponding to the second phase. Once the opening is done, LauchRelax (111) performs a sequence of top-down calls to Next. This time, FTIS (115) can return true and [d2, t2, a2]. Going up, Relax (114) returns true, the 2d Map (113) extracts the values corresponding to t2 and a2 from the store and returns true, the 1st Map (112) prints the values and returns true, LauchRelax (111) returns true.

2.3. Third Next

This step starts as the previous one, i.e., FTIScan (111) first returns false and LauchRelax re-initializes the process for the next evaluation phase. However, the next following the re-initialization also returns false (because there are no more results). Thus, LaunchRelax (111) re-closes, records yet another evaluation phase and re-opens. This time, the opening fails because Relax (114) has built all the pattern trees it can build. So it returns false upon opening. In that case, LauchRelax (111) stops trying and returns false. The evaluation is thus over.

3) Close

LauchRelax (111) calls close recursively on its descendants. Each cleans its data structures.

Considering that FTISCAN, RELAX and LAUCHRELAX have standard APIs and further bearing in mind that open, close, stop and next can also be realized in a known per se manner, the BESTOF operator can be integrated in any query processor, preferably although not necessarily, relying on a standard algebra. In the latter example, standard MAP operations but, obviously, any other operations (e.g., SELECT, JOIN) can be used.

The present embodiment has been described in great detail focusing in pipeline calculation that captures, “head preference” pipeline criterion (e.g. extract documents with the sought words in the title and then in the abstract, etc. It can also capture other criteria, such as proximity. The granularity of the proximity criterion is dictated by the structure of the the pattern. Thus, reverting to the specific example of FIG. 7A, it would be possible to capture word combination that reside in the title, but not at, say sub-title parts.

Consider now the exemplary tree pattern of FIG. 7C, where, as shown, sentence (75) is a child node of title (76). By this specific example it would be possible to capture the combination of “query” and “language” when appearing within the same sentence in the title. This brings about a finer granularity (for the proximity feature) as compared to, say the pattern tree of FIG. 7A, in the case that the title contains more than one sentence. Obviously, the discussion of the head preference and proximity criterion is not bound to the basic predicate that concerns combination of key words. This example, illustrates, yet another non limiting use of the structural positioning of words for use in relevance ranking.

Other features can be captured, e.g. re-occurrence, where the more instances of the sought word(s) (or phrase etc), the higher the rank conferred thereto. For example, to take into account co-occurrence, a parameter having two values (T for True and F for False) is added to the BESTOF in order to signify the weight that should be given to co-occurrence. When the parameter is operative it is set to T, otherwise, when it is inactive it is set to F.

For instance, for $bestDoc in BestOf(myDocuments, “query language”, T, //title, //abstract, //*) Then, given two documents containing “query language” in their title, the one with the most occurrences of the words is preferred over the other. Note that by this non-limiting example, head preference prevails over re-occurrence. Thus, for an active re-occurrence parameter (i.e. set to T) in the case that there is a document A with only one instance of the word in the title and a document B with many re-occurrences of the word in the abstract, A has a higher rank. The mutual relationship between the head preference and re-occurrence may be altered, using say a parameter with higher resolution values. Consider, for example, a situation where the re-occurrence parameter can receive any value in the 0-1 interval. Thus, for example, by giving a stronger weight (e.g., 0.9), a document with many occurrences of the words in the abstract may be preferred over one with one simple occurrence in the title. Those versed in the art will readily appreciate that the latter examples are by no means limiting and the re-occurrence parameter may be integrated to the relevance ranking algorithm in any desired manner, depending upon the particular application.

Note that, re-occurrence as well as any criterion requiring the aggregation of all results to be evaluated has a cost: the loss of the pipeline evaluation strategy that constitute the second part of the invention. In other words, the results should be collected and evaluated (e.g. to calculate how many time the sought word [or more complex predicate] appears), before results are delivered to the user.

The present embodiment illustrated in a non limiting manner how to provide inter alia (i) a mechanism to express how relevance should be computed in the semi-structured context and (ii) a scalable way to efficiently evaluate a query on a large database so as to return the most relevant results fast.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity, but those versed in the art will readily appreciate that various alterations and modification may be carried out, without departing from the scope of the following claims:

1) A method for evaluating queries applied to semi-structured data, comprising:
i) providing a query for the semi-structured data, the query includes indication of relevance ranking of sought results; wherein said indication includes specification according to the structural positioning of words in the semi-structured data;
ii) evaluating the query vis-a-vis the semi-structured data in accordance with said indicated relevance ranking; and
iii) providing at least one result, if any, where each result includes a portion of said semi-structured data that meets said query.

2) The method according to claim 1, wherein said evaluating is performed in a pipelined fashion including: said evaluating is stopped upon meeting a pre-defined evaluation criterion.

3) The method according to claim 2, wherein said criterion being a number of the results reaching or exceeding a predefined number.

4) The method according to claim 2, wherein in response to a user command said evaluation is resumed, and wherein said evaluation step (b) further includes:
resuming evaluating the query vis a vis the data that were not evaluated before.

5) The method according to claim 1, wherein said evaluating step (b) includes:
evaluating said query against said semi-structured data in a non-pipelined manner.

6) The method according to claim 1, wherein said evaluating step (b) includes:
evaluating said query vis-a-vis said semi-structured data in either mode (A) or (B) depending upon a predefined criterion, wherein (A) being a non-pipelined and (B) being pipelined.

7) The method according to claim 6, wherein said predefined criterion is based on a statistical model that estimates the number of results and wherein in case of large number of estimated results, said pipelined evaluation (B) is selected and in case of estimated small number or zero results said non-pipelined evaluation (A) is selected.

8) The method according to claim 2, wherein said indicating relevance ranking being by means of BESTOF operator, where BESTOF being defined as
BESTOF (F, SP, P1, P2, P3, . . . )
Where:
F: a forest of XML nodes;
SP: a string predicate;
P1, P2, . . . , Pn: 1 to many XPath expressions;
The result of the BESTOF operation is a re-ordered sub-part of the forest F defined as follows: BESTOF(F, SP, P1, P2, . . . , Pn)=Fres={N1, N2, N3, . . . , Nm} with:
For all nodes N in F, if there exists j in [1,n] such that Pj applied to N satisfies SP then N is part of Fres.
For all i in [1, m] there exists j in [1,n] such that Pj applied to Ni satisfies SP. Let jmin(i) be the smallest such j for a given I
For all i in [1, mn−1], (jmin(i)<jmin(i+1)) or (jmin(i)=jmin(i+1) and Ni is before Ni+1 in F).

9) The method according to claim 8, wherein using said operator includes invoking LAUNCHRELAX, RELAX and FTISCAN functions.

10) The method according to claim 1, wherein said semi-structured data include XML documents.

11) The method according to claim 10, wherein said query language for semi-structure documents being Xquery.

12) A method for constructing queries for application to semi-structured data, comprising:
i. providing a query for the semi-structured data, the query includes indication of relevance ranking of sought results; wherein said indication includes specification according to the structural positioning of words in the semi-structured data;
ii. transmitting the query for evaluation vis-a-vis the semi-structured data in accordance with said indicated relevance ranking; and
iii. receiving at least one result, if any, where each result includes a portion of said semi-structured data that meets said query.

13) The method according to claim 12, wherein said evaluating is performed in a pipelined fashion including: said evaluating is stopped upon meeting a pre-defined evaluation criterion.

14) The method according to claim 13, wherein said criterion being a number of the results reaching or exceeding a predefined number.

15) The method according to claim 13, wherein in response to a user command said evaluation is resumed, and wherein said evaluation step (b) further includes:
resuming evaluating the query vis a vis the data that were not evaluated before.

16) The method according to claim 12, wherein said evaluating step (b) includes:
evaluating said query against said semi-structured data in a non pipelined manner.

17) The method according to claim 12, wherein said evaluating step (b) includes:
evaluating said query vis-a-vis said semi-structured data in either mode (A) or (B) depending upon a predefined criterion, wherein (A) being a non-pipelined and (B) being pipelined.

18) The method according to claim 17, wherein said predefined criterion is based on a statistical model that estimates the number of results and wherein in case of large number of estimated results, said pipelined evaluation (B) is selected and in case of estimated small number or zero results said non-pipelined evaluation (A) is selected.

19) The method according to claim 13, wherein said indicating relevance ranking being by means of BESTOF operator, where BESTOF being defined as BESTOF (F, SP, P1, P2, P3, . . . )
Where:
F: a forest of XML nodes;
SP: a string predicate;
P1, P2, . . . , Pn: 1 to many XPath expressions;
The result of the BESTOF operation is a re-ordered sub-part of the forest F defined as follows: BESTOF(F, SP, P1, P2, . . . , Pn)=Fres={N1, N2, N3, . . . , Nm} with:
For all nodes N in F, if there exists j in [1,n] such that Pj applied to N satisfies SP then N is part of Fres.
For all i in [1, m] there exists j in [1,n] such that Pj applied to Ni satisfies SP. Let jmin(i) be the smallest such j for a given I
For all i in [1, m−1], (jmin(i)<jmin(i+1)) or jmin(i)=jmin(i+1) and Ni is before Ni+1 in F).

20) The method according to claim 19, wherein using said operator includes invoking LAUNCHRELAX, RELAX and FTISCAN functions.

21) The method according to claim 12, wherein said semi-structured data include XML documents.

22) The method according to claim 21, wherein said query language for semi-structure documents being Xquery.

23) A method for constructing queries for application to semi-structured data, comprising:
i. providing a query for the semi-structured data such that said query is formatted to indicated relevance ranking of sought results; wherein said indication includes specification according to the structural positioning of words in the semi-structured data;
ii. transmitting the query for evaluation vis-a-vis the semi-structured data in accordance with said indicated relevance ranking;
iii. receiving at least one result, if any, where each result includes a portion of said semi-structured data that meets said query.

24) The method according to claim 23, wherein said query is in Xquery language, and wherein said data being XML documents and wherein said result being at least one document or portion thereof, that meets said query.

25) The method according to claim 23, wherein said query is formatted to indicated relevance ranking by means that include calling to at least one external function.

26) The method according to claim 24, wherein said query is formatted to indicated relevance ranking by means that include calling to at least one external function.

27) A method for evaluating queries applied to semi-structured data, comprising:
i. providing a query for the semi-structured data, the query includes indication of relevance ranking of sought results; wherein said indication includes specification according to the structural positioning of words in the semi-structured data.
ii. evaluating the query vis-a-vis the semi-structured data in accordance with said indicated relevance ranking; and
iii. providing at least one result, if any, where each result includes a portion of said semi-structured data that meets said query,
whereby, results that meet said query in compliance with said relevance ranking, are provided, irrespective of the size of the semi-structured data, provided that the user has not stopped the evaluation process.

28) A computer program product comprising:
computer code for constructing a query for application to semi-structured data, the computer code further facilitates incorporation in the query means for indicating relevance ranking of sought results;
wherein said indication includes specification according to the structural positioning of words in the semi-structured data,
whereby said query is capable of being evaluated vis a vis the semi-structured data in accordance with said indicated relevance ranking for receiving at least one result, if any, where each result includes a portion of said semi-structured data that meets said query.

29) The product according to claim 28, wherein said evaluating is performed in a pipelined fashion including: said evaluating is stopped upon meeting a pre-defined evaluation criterion.

30) The product according to claim 29, wherein said criterion being a number of the results reaching or exceeding a predefined number.

31) The product according to claim 29, wherein in response to a user command said evaluation is resumed, and wherein said evaluation step (b) further includes:
resuming evaluating the query vis a vis the data that were not evaluated before.

32) The product according to claim 28, wherein said evaluating step (b) includes:
evaluating said query against said semi-structured data in a non-pipelined manner.

33) The product according to claim 28, wherein said evaluating step (b) includes:
evaluating said query vis-a-vis said semi-structured data in either mode (A) or (B) depending upon a predefined criterion, wherein (A) being a non-pipelined and (B) being pipelined.

34) The product according to claim 33, wherein said predefined criterion is based on a statistical model that estimates the number of results and wherein in case of large number of estimated results, said pipelined evaluation (B) is selected and in case of estimated small number or zero results said non-pipelined evaluation (A) is selected.

35) The product according to claim 29, wherein said indicating relevance ranking being by means of BESTOF operator, where BESTOF being defined as BESTOF (F, SP, P1, P2, P3, . . . )
Where:
F: a forest of XML nodes;
SP: a string predicate;
P1, P2, . . . , Pn: 1 to many XPath expressions;
The result of the BESTOF operation is a re-ordered sub-part of the forest F defined as follows: BESTOF(F, SP, P1, P2, . . . , Pn)=Fres={N1, N2, N3, . . . , Nm} with:
For all nodes N in F, if there exists j in [1,n] such that Pj applied to N satisfies SP then N is part of Fres.
For all i in [1, m] there exists j in [1,n] such that Pj applied to Ni satisfies SP. Let jmin(i) be the smallest such j for a given I
For all i in [1, m−1], (jmin(i)<jmin(i+1)) or (jmin(i)=jmin(i+1) and Ni is before Ni+1 in F).

36) The product according to claim 35, wherein using said operator includes invoking LAUNCHRELAX, RELAX and FTISCAN functions.

37) The product according to claim 28, wherein said semi-structured data include XML documents.

38) The product according to claim 37, wherein said query language for semi-structure documents being Xquery.

39) A system for evaluating queries applied to semi-structured data, comprising:
receiver for receiving a query for the semi-structured data, the query includes indication of relevance ranking of sought results; wherein said indication includes specification according to the structural positioning of words in the semi-structured data;
evaluator for evaluating the query vis-a-vis the semi-structured data in accordance with said indicated relevance ranking; said evaluation is capable of providing at least one result, if any, where each result includes a portion of said semi-structured data that meets said query.

40) A system for constructing queries for application to semi-structured data, comprising:
generator for generating a query for the semi-structured data, the query includes indication of relevance ranking of sought results; wherein said indication includes specification according to the structural positioning of words in the semi-structured data;
transmitter for transmitting the query for evaluation vis-a-vis the semi-structured data in accordance with said indicated relevance ranking; and
receiver for receiving at least one result, if any, where each result includes a portion of said semi-structured data that meets said query.

41) A system for evaluating queries applied to semi-structured data, comprising:
receiver for receiving a query for the semi-structured data, the query includes indication of relevance ranking of sought results; wherein said indication includes specification according to the structural positioning of words in the semi-structured data.
evaluator for evaluating the query vis-a-vis the semi-structured data in accordance with said indicated relevance ranking; said evaluator is capable of providing at least one result, if any, where each result includes a portion of said semi-structured data that meets said query,
whereby, results that meet said query in compliance with said relevance ranking, are provided, irrespective of the size of the semi-structured data, provided that the user has not stopped the evaluation process.
